(19) United States
(12) Patent Application Publication
(10) Pub. No.: US 2014/0267758 A1
(43) Pub. Date: Sep. 18, 2014

(54) STEREO INFRARED DETECTOR

(71) Applicant: Pelco, Inc., Clovis, CA (US)

(72) Inventors: Bryan K. Neff, Fresno, CA (US); Farzin Aghdasi, Clovis, CA (US)

(21) Appl. No.: 13/841,658

(22) Filed: Mar. 15, 2013

(51) Int. Cl. H04N 13/02; H04N 5/33

(52) U.S. Cl. CPC H04N 13/0242; H04N 5/33
USPC 348/164

(57) ABSTRACT

Existing passive infrared (PIR) sensors rely on motion of an object to detect presence and do not provide information about the number of objects or other characteristics of objects in a field of view such as distance or size. Disclosed herein are apparatuses and corresponding methods for detecting a source of infrared emission. Example embodiments include two infrared sensors for imaging and a processor configured to use the images to detect a presence of an infrared source and output a signal based on the presence. Example apparatuses and corresponding methods provide for measurement of an infrared source's speed, size, height, width, temperature, or range using analytics. Some advantages of these systems and methods include low cost, stereo view, and detection of people, children, or objects with infrared/thermal sensors of low pixel count.

### BACKGROUND OF THE INVENTION

Passive infrared (PIR) sensors may be used to detect movement of an object. PIR sensors operate by detecting changes in IR radiation to detect a moving object (human, animal, vehicle, etc.) if the object is at a different temperature than its background or surroundings.

### SUMMARY OF THE INVENTION

Existing PIR sensors depend on movement of an object to detect the object. Infrared/thermal cameras may have very good resolution (e.g., 320 pixels per row) but are currently very costly and require human monitoring to distinguish different types of infrared sources. Infrared camera manufacturers continue to increase pixel counts of sensor arrays in an effort to improve image resolution for use in object or person identification applications.

Embodiments of the present invention use low-resolution thermal sensors (e.g., 32 or 8 pixels per row) in stereo (dual sensors) in combination with image processing or analytics to detect additional information about objects, even stationary objects, such as the range/distance of an object from the sensors. A signal may be output to indicate the presence or nature of a detected source. Specifically, children may be distinguished from adults or inanimate objects, enabling embodiments of the invention to be used in a wide variety of settings as a safety mechanism or feature. One advantage of using stereo infrared sensors is that the sensor can be placed in many more environments at many angles and can determine three-dimensional information about an infrared source. The combination of stereo thermal sensors and object detection analytics provides a sophisticated, versatile, and low-cost detector.

In one embodiment, an apparatus, or corresponding method, for detecting a source of infrared emission includes first and second infrared sensors configured to provide at least one first and one second image, respectively. The system also includes a processor operatively coupled to the first and second infrared sensors and configured (1) to process the first and second images in conjunction with each other to detect the presence of a source as a function of the first and second images and (2) to output a signal based on the presence of the source.

In some embodiments, the processor is further configured to determine at least one characteristic of the source based upon the first and second images and to output the signal based upon the characteristic. In embodiments in which the processor is configured to determine at least one characteristic of the source, the processor may further assign the source to a class based upon the characteristic and output the signal as a function of the class. The class may include human, animal, inanimate object, adult, or child, for example. Further, the characteristic of the source that is determined may include speed, size, height, width, temperature, or range, for example.

In some embodiments, the processor is configured to detect edges of the source in the first and second images and determine a characteristic of the source based on a combination of the edges. In some embodiments, the first and second infrared sensors have sensor dimensions of fewer pixels than are required to distinguish detailed human features. In some embodiments, the first and second infrared sensors have sensor dimensions of no greater than 300 pixels in length in either row or column axes. In some embodiments, the processor is configured to perform a noise reduction on the first and second images.

In some embodiments, the processor is configured to provide notification if the apparatus deems detection of the source is unreliable or unavailable based on an infrared signature of an environment within a field of view of the first and second sensors. In some embodiments, the first and second images include negative infrared images of the source relative to a background within a field of view of the first and second sensors. In some embodiments, the processor is configured to process the first and second images in conjunction with each other to determine a shape of the source in three dimensions, a distance of the source from the first and second infrared sensors, or both.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram that illustrates a vehicle equipped with an apparatus according to an embodiment of the invention for detecting a source of infrared emission.

FIG. 2A is a block diagram illustrating interconnections according to an embodiment of the invention among a detected person, infrared sensors, images from the sensors, and a processor.

FIG. 2B is a schematic diagram illustrating dimensions relevant in calculating a location of an object based on acquired stereo images.

FIG. 3A is a flow diagram that illustrates a procedure for detecting a source of infrared emission.

FIG. 3B is a flow diagram that illustrates a procedure according to an embodiment of the invention for detecting a source of infrared emission, incorporating noise reduction and edge detection.

FIG. 4A is a diagram illustrating an elevator equipped with an apparatus according to an embodiment of the invention for detecting a source of infrared emission.

FIG. 4B is a diagram illustrating an automatic door equipped with an apparatus according to an embodiment of the invention for detecting a source of infrared emission.

### DETAILED DESCRIPTION OF THE INVENTION

A description of example embodiments of the invention follows.

The word “infrared,” as used herein, denotes the portion of the electromagnetic spectrum between visible wavelengths and microwave wavelengths, or from about 700 nanometers to about 1 millimeter. This region covers near-infrared, mid-infrared, and far-infrared wavelengths. This region of wavelengths, or at least a portion of this region, may also be referred to as “thermal” wavelengths.

Existing passive infrared (PIR) sensors detect changes in IR radiation to detect a moving object (human, animal, vehicle, etc.) that is at a different temperature from its surroundings or background. These sensors have advantages over visible optical approaches since PIR sensors use the thermal emission of an object, which is not dependent on scene lighting and is effective during the day or night. Existing sensors detect a change in IR radiation to detect a moving object, such as a human.

A disadvantage of existing PIR sensors is if the object (human, animal, vehicle, etc.) remains stationary, the sensor cannot register that an object is still in its detection area. In addition, existing PIR sensors include only a single pixel or a few pixels, limiting them to applications needing only presence information. There is no ability to provide information about the number of objects in the scene or the size of the object in the scene.

Single imager thermal solutions are limited in the possible locations in which they may be usefully installed or mounted because they must map a two-dimensional (2D) object into a three-dimensional (3D) space. If placed directly above an object, for example, a single imager cannot determine that object's height. In addition, single imager thermal solutions must be calibrated to detect the height or the width of an object/source. Traditional 2D analytic approaches require that a sensor be placed in a certain position to detect a person. It is not possible to determine accurately a distance from the sensor to an object in the field of view using traditional 2D analytic approaches.

Applicants have discovered that new low-resolution, low cost thermal imagers, such as those based on thermopile or microbolometer technology, can be used in stereo and combined with analytics to create a more sophisticated, yet low cost, detector/sensor. By utilizing low-resolution thermal imagers in stereo, and an analytic processor, a sensor can detect the height or location of a person and determine if that person is a child, for example. This new sensor can prevent accidents with automatic doors and elevators by not allowing the door to close if a child remains within the door's closing area, or if a human is too small to be detected by a traditional sensor. The new sensor can also be used in other safety applications where it is critical to know the location in space of people or appendages in order to provide an automatic stop to machinery.

This new sensor can detect the presence of children in extreme low-light conditions. This sensor can also be usefully installed in many more locations than a single imager thermal sensor. This sensor can be placed on an automobile to detect the presence of a stationary child, and notify the driver if a child is present, for example. Unlike existing PIR sensors, this sensor does not rely on motion of the object in order to detect the object. Embodiments of this invention utilize a combination of new low-resolution thermal image sensors, which can provide very accurate detection of objects when combined with analytics and 3D imaging to provide information such as distance, height, or size.

In some embodiments, the first and second infrared sensors have sensor dimensions of fewer pixels than are required to distinguish human features. In some of these embodiments, the sensor dimensions are of fewer pixels than are required to distinguish human appendages such as arms, legs, or head. In other of these embodiments, the sensor dimensions are of fewer pixels than are required to distinguish body shape. In yet other of these embodiments, the sensor dimensions are of fewer pixels than are required to distinguish small appendages such as fingers. In still other of these embodiments, the sensor dimensions are of fewer pixels than are required to distinguish facial features.

FIG. 1 is a diagram that illustrates a vehicle 101 equipped with a detecting apparatus 105 for detecting a source of infrared emission according to an embodiment of the invention. The detecting apparatus 105 includes a first infrared sensor 106 and a second infrared sensor 108. The infrared sensors 106, 108 have a field of view 110. The first infrared sensor 106 is configured to provide at least one first image, and the second infrared sensor 108 is configured to provide at least one second image. The detecting apparatus 105 also includes a processor (not shown) operatively coupled to the first and second infrared sensors 106, 108. The detected source of infrared emission in the field of view 110 may be a person, child, animal, wall, post, or other objects.

The processor in the detecting apparatus 105 in FIG. 1 is configured to process the first and second images in conjunction with each other to detect a presence of an infrared source as a function of the first and second images and to output a signal based on the presence or nature of the source. According to embodiments of this invention, first and second images are processed in conjunction with each other to detect a presence of a source as a function of the first and second images. This means that both images are processed and taken into account to determine the presence of the source. One image may be processed before the other, so long as both images are taken into account in determining whether a detection has occurred or a nature of a source has been determined.

In one example of processing the images in conjunction with each other, the first image is used to make a preliminary detection of an object, and the second image is used to confirm the detection. In another example, edges of a source object are detected in both the first and second images to determine a location or position of a feature of the object. In yet another example, as will be shown below in connection with a description of FIG. 2B, a location of a point on an object is determined based upon incident positions of rays on sensors, a separation distance of the sensors, and a location of optical components.

FIG. 2A is a block diagram illustrating interconnections according to an embodiment of the invention between a detected person 215, first and second infrared sensors 206 and 208, respectively, first and second images 207 and 209, respectively, processor 220, and output signal 225. The first and second infrared sensors 206, 208 detect infrared rays emanating from the person 215. The sensors 206, 208 provide the images 207, 208, respectively, to the processor 220. The processor 220 processes the images 207, 208 in conjunction with each other to determine that that the person 215 is detected. The processor 220 outputs the signal 225, which indicates that the person 215 is detected. In other embodiments, the output signal 225 indicates that no person or other object is detected. In other embodiments, the output signal indicates information about the person 215 or another detected object, such as size, height, temperature, width, distance of the object from the sensors 206, 208, etc.

FIG. 2B is a schematic diagram illustrating dimensions relevant in calculating a location of an object based on acquired stereo images. FIG. 2B demonstrates how, using two thermal imagers and the principles of calculating image disparity, it is possible to determine the position and height of an object. An object 216 is located at a position 217 designated by the coordinates x, y, z. Infrared rays 230, 231 from the object 216 pass through lenses 235, 236, respectively. The ray 230 is focused onto a first infrared sensor 240 at a position 245 designated by the coordinates x_{L}′, y_{L}′. Similarly, the ray 231 is focused by the lens 236 onto a second infrared sensor 241 at the location 246 designated by coordinates x_{R}′, y_{R}′. The lenses 235, 236 are separated by a distance b 251. The lenses 235, 236 are located at a height f 250 from the respective infrared sensors 240, 241. The position 217 designated by x, y, z on the object 216 is calculated as follows:

x=b(x_{L}′+x_{R}′)/2(x_{L}′−x_{R}′)

y=b(y_{L}′+y_{R}′)/2(x_{L}′−x_{R}′)

z=bf/(x_{L}′−x_{R}′)

Other point(s) (not shown) on the object 216 may be similarly calculated to determine a height or width of a source, for example.

Similar calculations may be used in other embodiments, for example, to calculate a person's height. By computing the coordinates of the person's foot and comparing those coordinates to the coordinates of the person's head, it is possible to determine the person's height. Height can then be input into the analytic detection process to determine whether the person is a child.

FIG. 3A is a flow diagram that illustrates a procedure 300a for detecting a source of infrared emission. At 370, a first infrared image is detected at a first position. At 371, a second infrared image is detected at a second position different from the first position. At 372, the first and second images are processed in conjunction with each other to detect a presence of a source as a function of the first and second images and to output a signal based on the presence of the source.

In other embodiments, the procedure includes determining at least one characteristic of the source based upon the first and second images, and the signal is output based upon the characteristic of the source. The characteristic of the source may include a speed, size, height, width, temperature or range of the source. For example, a position of the source, or of one or more points on the source, may be calculated as shown in FIG. 2B. Further, in some embodiments the source is assigned to a class based on the determined characteristic, and the signal is output based on the class assignment. For example, classes may include human, animal, inanimate object, adult, or child.

In some embodiments, the processing at 372 involves detecting edges of the source in the first and second images to determine at least one characteristic of the source based on a combination of the edges. In some embodiments, the processing at 372 includes noise reduction. For example, noise reduction may be performed on the first image as shown later in conjunction with FIG. 3B, and noise may be similarly reduced in the second image. In some embodiments, the processing at 372 further includes providing notification if detection of the source is deemed to be unreliable or unavailable based on an infrared signature of an environment within a field of view of the first and second sensors. For example, if the temperature of the source to be detected is close to a temperature of a surrounding environment, a source may not be clearly distinguishable from its surroundings in a thermal image. In this case, notice may be provided, or an alarm sounded, to indicate that detection of relevant sources is unavailable. For example, in FIG. 1, detection apparatus 105 may be programmed to detect persons or other mammals based upon, in part, body temperature. However, if the surrounding environment in the field of view 110 is similar in temperature to a body temperature, the detection apparatus 105 may determine that detection is unreliable or unavailable and signal to, or give notification to, a driver of the vehicle 101 to take extra precautions.

In some embodiments, detecting the first and second infrared images at 370, 371, respectively, includes detecting negative infrared images of the source relative to a background within a field of view of the first and second sensors. Negative infrared images may be used where, for example, an environmental or background temperature is higher than a temperature of the infrared source to be detected. In this case, the source to be detected may emit infrared radiation at a lower intensity than the source's surroundings.

In other embodiments, the processing at 372 includes determining a shape of the source in three dimensions, a distance of the source from the first and second infrared sensors, or both. For example, distance of the source from the infrared sensors may be determined according to the diagram shown in FIG. 2B.

FIG. 3B is as a flow diagram illustrating a procedure 300b for detecting a source of infrared emission. At 380, the procedure begins. At 382, multiple infrared images are acquired using a first infrared sensor, which includes the infrared sensor's acquiring multiple images in order to facilitate noise reduction at 384 by averaging the multiple images.

At 384, the multiple images are averaged to reduce noise in the output of the first infrared sensor. At 386, a gradient of gray level pixel values is calculated. The gradient of the image (these images are only grey scale and not color) provides input for edge detection, for example. The edges may belong to the background, as well as to the object of interest. The binarized image may be used as a mask to select only those strong edges that belong to the object of interest, such as the contour of a person's body. The coordinates of the selected edges may be used by the processor. The processor may calculate width and height of the object as seen from the sensors, and may also calculate the distance “z”.

At 388, a histogram of gray level pixel values is calculated. At 390, if the calculated histogram is bimodal, then the procedure continues to 392. If the histogram is not bimodal, then the procedure begins anew at 380. At 392, the valley between the two modes of the bimodal histogram is found, and the value of the valley is set as a threshold T. At 394, the threshold T is applied to binarize the image.

At 396, very small detected blobs are removed from the binarized image, and the remaining detected blobs are labeled as objects of interest. At 397, the edges corresponding to objects of interest are used to calculate features. Features may include size, shape, etc. Edge detection is performed on the objects of interest, and features such as size and shape in the 2D space are calculated.

At 398, features for calculation of stereo disparity between the first and second infrared sensors are stored. The features detected in 397 are stored to later apply the principles of image disparity to calculate features of the object in 3D space. At 399, the procedure 300b ends.

To summarize 388 to 396, object detection is facilitated in addition to object classification to remove unwanted objects from further processing. If a field of view is a largely cold environment, and one warm object or body without occlusion is detected in the middle of the image, then the histogram of the grey levels of this image includes two clear peaks (bimodal), with a clear valley in-between them. If the histogram is not bimodal in this manner, maybe there is no animal/human in the field of view, so the processor may do nothing further with that frame. If a valley is found in between a bimodal histogram, the valley can be used as a threshold to binarize the image, creating a white blob over a black background. Typically there is noise, giving rise to small blobs that may be discarded.

The operations outlined in FIG. 3B are for a single sensor. The image obtained from each sensor is processed by the operations outlined in the figure. The output of this processing operation is location of certain features of the object of interest. For instance, if the object of interest is a child, then an example of such a feature is the top of her head, the edges of her feet, or other point(s). By marking the location of these features in the image from each sensor, the images may be correlated or processed in conjunction with each other to determine the location of the same feature in both images. The processor 220 in FIG. 2A, for example, then uses coordinates related to the same anatomical features in the two images. These are the left and right coordinates in the two images of the same real world point in the object of interest. The processor 220 may then use the parameters shown in FIG. 2B, for example, to calculate “z,” the distance from the object to the “origin” of the coordinate system, the origin being the mid-point of the line joining the two sensors.

FIG. 4A is a diagram illustrating an elevator 455 equipped with a detection apparatus 405 according to an embodiment of the invention. The detection apparatus 405 includes first and second infrared sensors 406 and 408. The infrared sensors 406, 408 have a field of view 410, which includes the opening between the doors of the elevator 455. The doors 456a and 456b of the elevator 455 are stopped from closing when the detection apparatus 405 detects a person 415 within the field of view 410. The detection apparatus 405 may distinguish between a child and an adult, if necessary. The detection apparatus 405 may also detect an animal, inanimate object, adult, or child.

FIG. 4B is a diagram illustrating automatic doors 457a and 457b equipped with the detection apparatus 405 according to an embodiment of the invention. The first and second infrared sensors 406 and 408 have a field of view 411 that includes the area between the doors 457a-b. If the person of 415 is detected in the field of view 411, then the doors 457a and 457b remain open. In the use shown in FIG. 4B, the detection system 405 may be used as a safety mechanism to prevent doors 457a-b from closing when a child, adult, or objects is detected within the field of view 411. The detection apparatus 405 may also be used to open the doors 457a-b when a person or object is detected in the field of view 411. In this case, detection apparatus 405 may serve principally as an automatic door opener.

The new sensor according to embodiments of the invention may also be used in other safety applications where it is critical to know the location in space of people or appendages in order to provide an automatic stop to machinery.

It should be understood that embodiments or aspects of the present invention may be performed in hardware, firmware, or software. For example, the processes associated with performing FFTs, look-up table activities, and other activities described herein, may be performed on mobile electronics devices through use of software. The software may be any form of software that can operate in a manner consistent with the example embodiments described hereinabove. The software can be stored on any non-transient computer-readable medium, such as RAM, ROM, or any magnetic or optical media known in the art. The software can be loaded and executed by a processor to perform operations consistent with embodiments described above.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for detecting a source of infrared emission, the apparatus comprising:
a first infrared sensor configured to provide at least one first image;
a second infrared sensor configured to provide at least one second image; and
a processor operatively coupled to the first and second infrared sensors and configured (i) to process the first and second images in conjunction with each other to detect a presence of a source as a function of the first and second images and (ii) to output a signal based on the presence of the source.

2. The apparatus of claim 1, wherein the processor is further configured to determine at least one characteristic of the source based upon the first and second images and to output the signal based upon the at least one characteristic.

3. The apparatus of claim 2, wherein the processor is further configured to assign the source to a class based on the at least one characteristic and to output the signal as a function of the class.

4. The apparatus of claim 3, wherein the class includes one of human, animal, inanimate object, adult, or child.

5. The apparatus of claim 2, wherein the at least one characteristic of the source includes a speed, size, height, width, temperature, or range.

6. The apparatus of claim 1, wherein the processor is further configured to detect edges of the source in the first and second images and to determine at least one characteristic of the source based on a combination of the edges.

7. The apparatus of claim 1, wherein each of the first and second infrared sensors has sensor dimensions of fewer pixels than are required to distinguish human features.

8. The apparatus of claim 1, wherein each of the first and second infrared sensors has sensor dimensions of no greater than 300 pixels in length.

9. The apparatus of claim 1, wherein the processor is further configured to perform a noise reduction on the first and second images.

10. The apparatus of claim 1, wherein the processor is further configured to provide notification if the apparatus deems detection of the source is unavailable based on an infrared signature of an environment within a field of view of the first and second sensors.

11. The apparatus of claim 1, wherein the first and second images include negative infrared images of the source relative to a background within a field of view of the first and second sensors.

12. The apparatus of claim 1, wherein the processor is further configured to process the first and second images in conjunction with each other to determine a shape of the source in three dimensions, a distance of the source from the first and second infrared sensors, or both.

13. A method of detecting a source of infrared emission, the method comprising:
detecting a first infrared image at a first position;
detecting a second infrared image at a second position different from the first position; and
processing the first and second images in conjunction with each other (i) to detect a presence of a source as a function of the first and second images and (ii) to output a signal based on the presence of the source.

14. The method of claim 13, the processing further comprising:
determining at least one characteristic of the source based upon the first and second images, the outputting the signal being based upon the at least one characteristic of the source.

15. The method of claim 14, the processing further comprising:
assigning the source to a class based on the at least one characteristic, the outputting the signal being based on the class.

16. The method of claim 15, wherein the class includes one of human, animal, inanimate object, adult, or child.

17. The method of claim 14, wherein the at least one characteristic of the source includes a speed, size, height, width, temperature, or range.

18. The method of claim 13, the processing further comprising:
detecting edges of the source in the first and second images to determine at least one characteristic of the source based on a combination of the edges.

19. The method of claim 13, the processing further comprising:
performing a noise reduction on the first and second images.

20. The method of claim 13, the processing further comprising:
providing notification if detection of the source is deemed to be unavailable based on an infrared signature of an environment within a field of view of the first and second sensors.

21. The method of claim 13, wherein detecting the first and second infrared images includes, respectively, detecting first and second infrared images that are negative infrared images of the source relative to a background within a field of view of the first and second sensors.

22. The method of claim 13, the processing further comprising:
determining a shape of the source in three dimensions, a distance of the source from the first and second infrared sensors, or both.

23. A non-transitory computer-readable medium with computer software instructions stored thereon, the computer software instructions when executed by a processor causing an apparatus to:
detect a first infrared image at first position;
detect a second infrared image at a second position different from the first position; and
process the first and second images in conjunction with each other (i) to detect a presence of a source as a function of the first and second images and (ii) to output a signal based on the presence of the source.
